(19) United States
(12) Patent Application Publication
(10) Pub. No.: US 2015/0062347 A1
(43) Pub. Date: Mar. 5, 2015

(54) IMAGE PROCESSING METHODS FOR VISIBLE AND INFRARED IMAGING

(71) Applicant: SEMICONDUCTOR COMPONENTS INDUSTRIES, LLC, Phoenix, AZ (US)

(72) Inventor: Elaine W. Jin, Fremont, CA (US)

(73) Assignee: SEMICONDUCTOR COMPONENTS INDUSTRIES, LLC, Phoenix, AZ (US)

(21) Appl. No.: 14/470,841

(22) Filed: Aug. 27, 2014

Related U.S. Application Data
(60) Provisional application No. 61/870,417, filed on Aug. 27, 2013.

(51) Int. Cl. H04N 5/355; H04N 9/78; H04N 5/33

(52) U.S. Cl. CPC H04N 5/355; H04N 5/332; H04N 9/78
USPC 348/164

(57) ABSTRACT

Imaging systems may be provided with image sensors for capturing information about incident light intensities in the visible and infrared bands of light. The means of capturing information about visible light may be unintentionally and undesirably influenced by infrared light. Similarly, the means of capturing information about infrared light may be unintentionally and undesirably influenced by visible light. Storage and processing circuitry may correct for the undesired influence of infrared and visible light on the signal data from the visible and infrared sensors, respectively. The correction may be determined or chosen based on a detection of the illuminant type of the imaged scene. The correction may alternatively be universal, and applicable to images of scenes illuminated by any illuminant.

This application claims the benefit of provisional patent application No. 61/870,417, filed Aug. 27, 2013, which is hereby incorporated by reference herein in its entirety.

### BACKGROUND

This relates generally to imaging devices, and more particularly to imaging devices with both visible and infrared imaging capabilities.

Modern electronic devices such as cell phones, cameras, computers, and gaming platforms often use digital image sensors. Image sensors may be formed from a two-dimensional array of light sensing pixels arranged in a grid. Each pixel may include a photosensitive circuit element that converts the intensity of the incident photons to an electrical signal. Image sensors may be formed using CCD pixels or CMOS based pixels. Image sensors may be designed to provide visible images that may be viewed by the human eye.

Image sensors may also be designed to provide information about light outside of the visible spectrum, namely near infra-red (sometimes referred to herein as near IR, or NIR) light. Information about the NIR spectrum may be used by military and law enforcement personnel who operate in low-light conditions; it may also be used by machine systems for applications in autonomous transportation, machine learning, human-machine interaction, and remote sensing.

Some image sensors include pixel arrays having both color pixels (e.g., red, green, and blue pixels, sometimes referred to herein as RGB pixels) that are sensitive to visible light and infrared pixels that are sensitive to infrared light. This type of image sensor is sometimes referred to as an RGB-IR sensor. An RGB-IR sensor aims to provide information about both the visible spectrum of light and the NIR spectrum of light. Image pixels in such a sensor may be arranged in an array and designated as visible light channels (red, green, blue channels) and NIR channels. A filter may be placed over the photosensitive element of each pixel. Visible imaging pixels in the pixel array may include a color filter that passes a band of wavelengths in the visible spectrum, while infrared imaging pixels in the pixel array may include an infrared filter that passes a band of wavelengths in the infrared spectrum.

A dual band pass filter is sometimes placed over the pixel array to allow only visible light and a narrow band of NIR light to reach the pixel array. This can help reduce unwanted pixel sensitivity to wavelengths of light outside of these ranges. However, some pixels may still exhibit unwanted sensitivity to light outside of the designated detection range. For example, visible imaging pixels may exhibit sensitivity to infrared light and infrared imaging pixels may exhibit sensitivity to visible light.

A detection channel's unwanted sensitivity to light outside of the designated detection range can negatively influence image quality, causing inaccurate reproductions of color appearance correlatives such as lightness or hue in color images.

It would therefore be desirable to be able to provide a method to recover color images with improved color accuracy from an RGB-IR sensor.

### BRIEF DESCRIPTION OF THE DRAWINGS

FIG. 1 is a diagram of an illustrative electronic device having a camera module in accordance with an embodiment of the present invention.

FIG. 2 is a graph showing the spectral response of a dual band pass filter that may be used in a camera module of the type shown in FIG. 1 in accordance with an embodiment of the present invention.

FIG. 3 is a top view of a pixel array that includes both color pixels and near infrared pixels in accordance with an embodiment of the present invention.

FIG. 4 is a graph showing the spectral sensitivities of the color pixels and near infrared pixels shown in FIG. 3 to light passing through the dual band pass filter shown in FIG. 1 in accordance with an embodiment of the present invention.

FIG. 5 is a diagram of an illustrative storage and processing circuitry having a functional unit which performs color accurate RGB recovery that may be used in system of the type shown in FIG. 1 in accordance with an embodiment of the present invention.

FIG. 6 is a flow chart of illustrative steps involved in the functioning of a color accurate RGB recovery unit of the type shown in FIG. 5, using illuminant detection to recover color accurate RGB signals in accordance with an embodiment of the present invention.

FIG. 7 is a flow chart of illustrative steps involved in the functioning of a color accurate RGB recovery unit of the type shown in FIG. 5, using a universal subtraction matrix to recover color accurate RGB signals in accordance with an embodiment of the present invention.

FIG. 8 is a flow chart of illustrative steps involved in the usage of the near infrared signal in accordance with an embodiment of the present invention.

### DETAILED DESCRIPTION

Image sensors are used in devices such as cell phones, cameras, computers, gaming platforms, and autonomous or remotely controlled vehicles to convert incident light into electrical signals, which may in turn be used to produce an image. Image sensors may include an array of photosensitive pixels. Image sensors may also include control circuitry that can operate and power the pixels, amplify the signal produced by the pixels, and transfer the data collected by the pixels to a processor, memory buffer, or a display. The size and sensitivity of the pixels may be varied to better suit the type of object being imaged. The pixels may be based on complementary metal oxide semiconductor technology (CMOS sensors), or be charged coupled devices (CCD sensors). The number of pixels on an image sensor may range from thousands to millions.

An array of image sensing pixels may be provided with a color filter array. A color filter array may include an array of filter elements, formed over the array of image sensing pixels. The filter elements may include red color filter elements, green color filter elements, blue color filter elements, and infrared filter elements. The filter elements may be optimized to pass one or more wavelength bands of the electromagnetic spectrum. For example, red color filters may be optimized to pass a wavelength band corresponding to red light, blue color filters to pass blue light, green color filters to pass green light, and infrared filters to pass infrared light. When a specific filter is formed over a pixel, the signal produced by the pixel may relate to the intensity of light of a specific wavelength band incident upon the pixel. Such a pixel may be called a channel for red light, blue light, green light, or infrared light when a filter optimized to pass red light, blue light, green light, or infrared light is formed above it, respectively.

While filter elements may be intended to pass particular wavelength bands of the electromagnetic spectrum, they may also pass light with wavelengths outside the intended bands. These unintended pass bands of the filter elements may be reduced by arranging a dual band pass filter over the entire image pixel array. A dual band pass filter may pass light in the visible spectrum and a narrow band of light in the infrared spectrum, while blocking light with wavelengths outside of those ranges.

An image sensor configured in this way may be used to simultaneously capture light intensity information about the light incident on the sensor both in the visible and near infrared (NIR) spectra. Despite the dual band pass filter arranged above the color and NIR channels, some pixels may exhibit sensitivity to light outside of the desired spectral range. For example, color filter elements over the visible imaging pixels may not completely block the NIR light that is passed by the dual band pass filter, leading to unwanted sensitivity to infrared light in the visible imaging pixels. Similarly, the NIR filter elements over the infrared imaging pixels may not completely block the visible light that is passed by the dual band pass filter, leading to unwanted sensitivity to visible light in the infrared imaging pixels.

The unwanted sensitivity to infrared light in the visible imaging pixels may deteriorate image quality. For example, the pixel signal produced by a visible imaging pixel that is partially sensitive to infrared light may be influenced by both visible light and infrared light that is incident on the pixel. If care is not taken, the unwanted passage of infrared light to color pixels in the image pixel array may result in color inaccuracies such as incorrect lightness and hue.

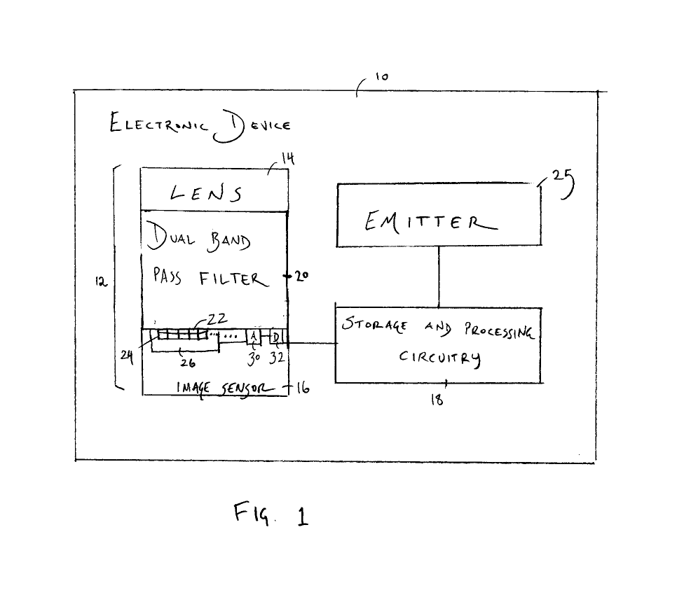

FIG. 1 is a diagram of an illustrative electronic device that uses an image sensor to capture images. Electronic device 10 of FIG. 1 may be a cell phone, camera, computer, gaming platform, autonomous or remotely controlled vehicle, or other imaging device that captures digital image data. Camera module 12 may include one or more lenses 14 and one or more corresponding image sensors 16. Image sensor 16 may be an image sensor system-on-chip (SOC) having additional processing and control circuitry such as analog control circuitry and digital control circuitry on a common image sensor integrated circuit die with an imaging pixel array.

Device 10 may include additional control circuitry such as storage and processing circuitry 18. Circuitry 18 may include one or more integrated circuits (e.g., image processing circuits, microprocessors, field programmable gate arrays, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be further processed and/or stored using processing circuitry 18. Processed image data may, if desired, be provided to external equipment (e.g., a computer or other device) using wired and/or wireless communications paths coupled to processing circuitry 18. Processing circuitry 18 may be used in controlling the operation of image sensors 16.

Imaging sensors 16 may include one or more arrays 26 of imaging pixels 24. Imaging pixels 24 may be formed in a semiconductor substrate using complementary metal-oxide-semiconductor (CMOS) technology or charge-coupled device (CCD) technology or any other suitable photosensitive transduction devices.

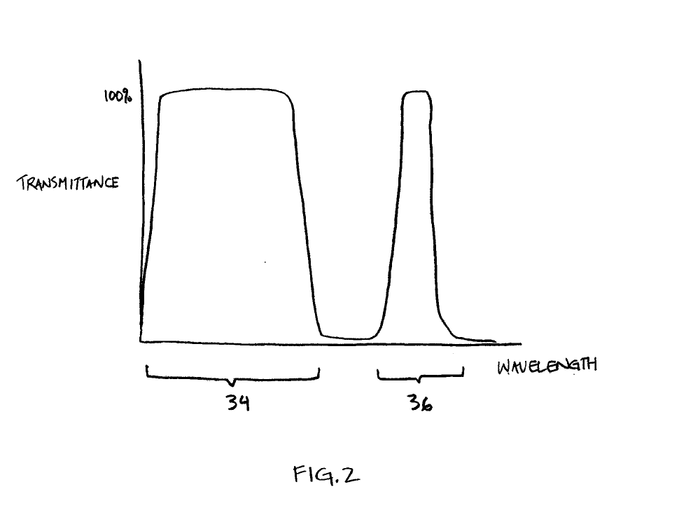

Camera module 12 may be used to convert incoming light focused by lens 14 onto an image pixel array (e.g., array 26 of imaging pixels 24). Light may pass through dual band pass filter 20 and filter array 22 before reaching image pixel array 26. The spectral transmittance characteristics of dual band pass filter 20 are illustrated in FIG. 2. Light that is incident upon dual band pass filter 20 is transmitted only if its wavelength lies in the visual band 34 or NIR band 36 of the electromagnetic spectrum.

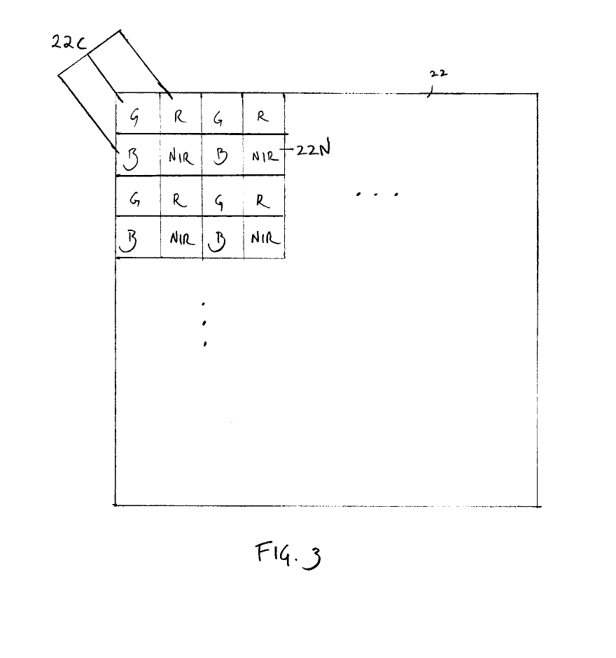

Color pixels and infrared pixels may be arranged in any suitable fashion. In the example of FIG. 3, color filter array 22 is formed in a “quasi-Bayer” pattern. With this type of arrangement, array 22 is composed of 2×2 blocks of filter elements in which each block includes a green color filter element, a red color filter element, a blue color filter element, and a near infrared filter element in the place where a green color filter element would be located in a typical Bayer array.

This is, however, merely illustrative. If desired, there may be greater or fewer near infrared pixels distributed throughout array 22. For example, array 22 may include one near infrared filter in each 4×4 block of pixels, each 8×8 block of filters, each 16×16 block of filters, etc. As additional examples, there may be only one near infrared filter for every other 2×2 block of filter, there may be only one near infrared filter for every five 2×2 blocks of pixels, there may be only one near infrared filter in the entire array 22 of filters, or there may be a one or more rows, columns, or clusters of near infrared filter in the array. In general, near infrared filter may be scattered throughout the array in any suitable pattern. The example of FIG. 3 is merely illustrative.

The light that passes through filters 22 may be converted into color and NIR channel signals. The color and NIR signals may correspond to the signals produced by the photosensitive pixels 24 beneath color filters 22C and NIR filters 22N (FIG. 3), respectively. Image sensor 16 (FIG. 1) may provide the corresponding channel signals to analog circuitry 30. Analog circuitry 30 may be used to amplify the signals from certain channels, or to normalize the signal values based on the empirically known sensitivity of a filter element (e.g., filter element 22C or 22N). Analog circuitry 30 may also process the signals by, for example, converting analog signals from the color and NIR channels into digital values, or interfacing with digital circuitry 32.

Digital circuitry 32 may process the digital signals further. For example, digital circuitry 32 may perform demosaicing on the input signals to provide red, green, blue and NIR signal data values for every pixel address, instead of having a single channel data value for a single pixel address corresponding to the filter element in the color filter array 22 directly above the imaging pixel 24. Digital circuitry 32 may also perform de-noising or noise reduction operations upon the signal data, preparing it for processing by storage and processing circuitry 18.

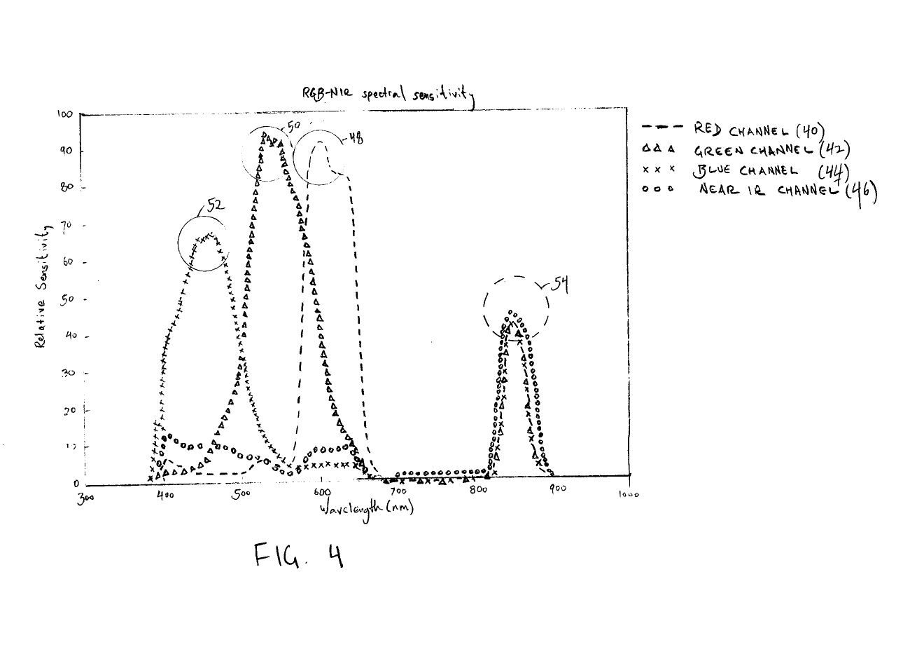

The spectral sensitivity of color and NIR channels reproduced in FIG. 4 motivates the operations performed upon the signal after it proceeds from camera module 12 to the storage and processing circuitry 18. FIG. 4 shows the sensitivity of the channels formed by arranging a dual band pass filter 20 above a color filter array 22 formed above an imaging pixel array 26. Though all four channels are approximately equally sensitive in the NIR band of light, this characteristic is appropriate only for the NIR channel 46, as it is intended to have peak sensitivity in the NIR band of light. The sensitivity of the color channels 40, 42, and 44 in the NIR band, as shown in region 54 of FIG. 4, makes an unwanted contribution to the signal value of the red, green, and blue channels, which may result in color inaccuracies.

The relative effect of these unwanted signal contributions may be reduced by using an emitter 25 to increase the intensity of visible light reflected by the scene to be imaged. The emitter 25 may emit a flash of visible light during or immediately before camera module 12 captures an image. This emission may be reflected by the scene to be imaged, and may result in a higher intensity of light in the visible band incident upon the camera module 12, specifically the lens 14. This emission may not consist entirely of visible light and may have a NIR component. Therefore, the use of emitter 25 may not sufficiently reduce the error in the color channel signals due to their unwanted sensitivity in the NIR band of light.

The sensitivity characteristics of the color channels 40, 42, and 44 in the visible band of light, shown in regions 48, 50, and 52 respectively, are appropriate and intended. The mild sensitivity of the NIR channel 46 in the visible region may be ignored if the application which utilizes the NIR data does not require a great deal of precision. Particular usage conditions and relative intensities of visible and NIR light reflected by the scene to be imaged may make this unwanted sensitivity of NIR channel in the visible region become a cause for significant error. To reduce the error in the NIR channel caused by unwanted sensitivity in the visible range, an emitter 25 may be used to emit a flash of NIR light during or immediately before camera module 12 captures an image. The reflection of the emitted NIR light which contributes to the NIR channel signal may reduce the relative effect of the unwanted sensitivity of the NIR channel in the visible range. However, the reflection of emitted NIR light may make an unwanted contributions to the color channel signals 40, 42, and 44 due to their sensitivities in the NIR band.

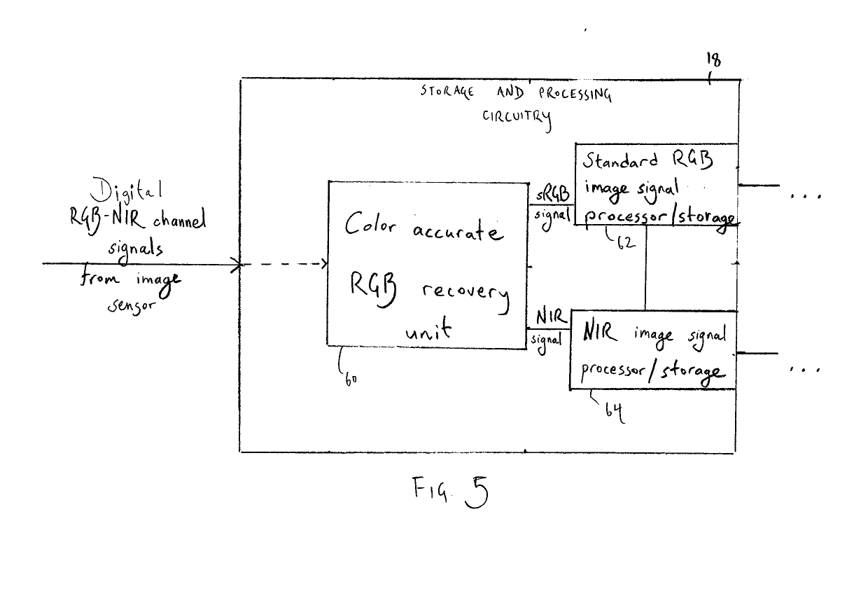

To address this issue and to produce accurate color image data and infrared image data based on pixel signals from pixel array 26, image processing circuitry such as storage and processing circuitry 18 (FIG. 1) may include a color accurate RGB recovery unit for accurately and efficiently separating image data corresponding to visible light from image data corresponding to infrared light. FIG. 5 is a diagram showing illustrative circuitry that may be included in storage and processing circuitry 18 of FIG. 1.

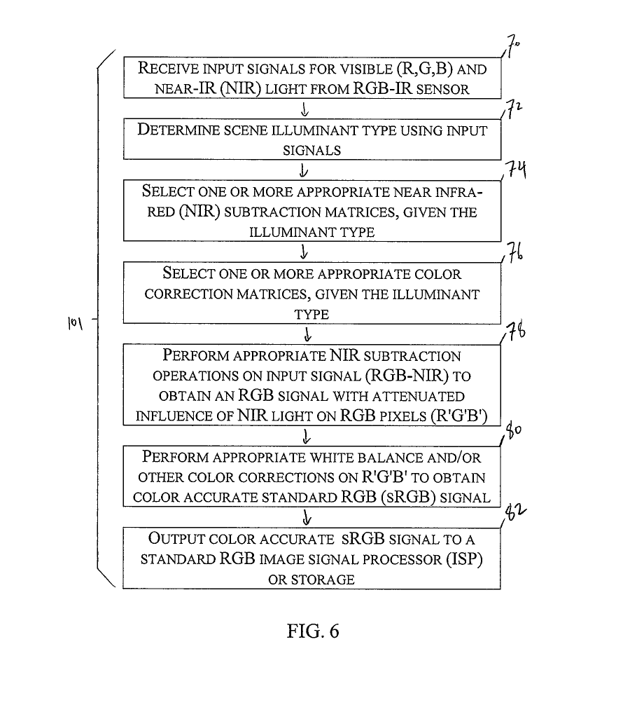

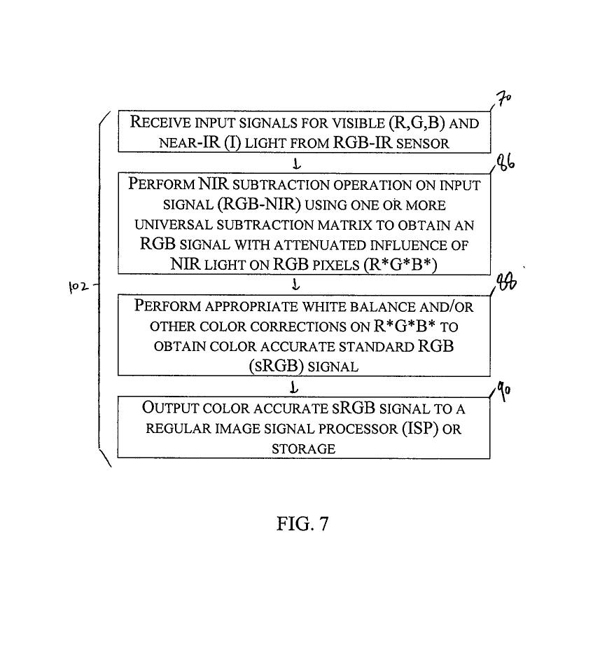

The RGB-NIR image signal from camera module 12, assumed for illustrative purposes to be a digital, demosaiced, and denoised signal processed by analog circuitry 30 and digital circuitry 32 proceeds to storage and processing circuitry 18 (relevant data path is enlarged in FIG. 5). The color accurate RGB recovery unit 60 (sometimes referred to herein as recovery unit 60) may be used to recover color accurate RGB signals and NIR signals from the input signal, which may be inaccurate representations of the actual light intensities in their respective intended pass bands. The inaccuracy may be caused by the error caused by unwanted sensitivity of color channels to light in the NIR band, and of NIR channels to light in the visible band. The input image signals received by the recovery unit 60 may be processed to produce a color accurate RGB image (e.g., using the method described in connection with FIG. 6 or using the method described in connection with FIG. 7). The selection of which method to employ in the processing of the input image signal data may be made by the user of device 10, or by storage and processing circuitry 18.

Recovery unit 60 may contain circuitry to store and process image signals. Recovery unit 60 may use circuitry to store and process image signals that is contained within storage and processing circuitry 18. To produce a color accurate RGB image signal, the data is first received by the recovery unit 60 (step 70, FIGS. 6 and 7).

In the processing method 101 detailed in FIG. 6, the input signals received in step 70 are used to determine a scene illuminant type in step 72. A scene illuminant type may be a category or profile of light that is characteristic to a typical natural or artificial light source. In step 72, a subset or processed subset of the input RGB-IR data signal may be used to classify the illuminant of the imaged scene as being proximate to one of a plurality of illuminant profiles. The illuminant profile may serve as an index for parameters or transformation matrices connected with operations on images of scenes illuminated by a particular illuminant. The illuminant type may also or alternatively be determined by an input by the user of the device 10, which may explicitly specify the illuminant type. The illuminant type may also or alternatively be determined by an input by the user of the device 10, which may specify a desired image effect or appearance, from which an appropriate illuminant profile may be inferred. The illuminant type may be determined by algorithms which classify images based on quantities derived or determined from the visible light signal values. The illuminant type may be determined by algorithms which classify images based on quantities derived or determined by both the visible and NIR signal values.

Illuminant type may be used in method 101 to select appropriate matrices for further processing of the input image signal. The degree to which the color signals of the RGB-NIR input signal need to be corrected may depend on the amount of IR light emitted by the illuminant of the scene that was imaged. For example, a scene illuminated by daylight or a tungsten light source may reflect more IR light to camera module 12 than a scene illuminant by fluorescent lights or light emitting diodes (LEDs).

The amount of IR light incident upon camera module 12 may introduce inaccuracy into the RGB signal data (input to recovery unit 60) due to the unwanted color channel sensitivities in the infrared spectral range (e.g., region 54 of FIG. 4). Therefore, after characterizing the illuminant type, the degree and type of processing that the RGB signal data requires may be determined. The determination may involve selecting one or more of a plurality of pre-set or dynamically generated transformation matrices or parameters for a processing algorithm. The transformation matrices or algorithm parameters may be updated in response to the illumination profiles of scenes most used by the user of device 10. The transformation matrices or algorithm parameters may be stored in look up tables, generated by the system, or specified by the user. The transformation matrices or algorithm parameters may be indexed by the illuminant type or linked to the illuminant type by some other means.

The transformation matrices or algorithm parameters in the illustrative steps in FIG. 6 are determined in steps 74 and 76. In step 74, one or more NIR subtraction matrices, used to correct for the unwanted color channel sensitivities in the NIR band (characteristic 54, FIG. 4) may be selected, based on the characteristic of the illuminant type determined in step 72. If desired, the one or more NIR subtraction matrices may also be determined based on the usage patterns of device 10. For example, an NIR subtraction matrix may be optimized to correct for color channels' unwanted sensitivity in the NIR band specifically in response to the illuminant types most often encountered by the user or controlling system. The one or more NIR subtraction matrices may be based on a calibration process in which the user of device 10 uses illuminants with known characteristics in the visible and NIR range to determine the degree of unwanted NIR sensitivity in the color channels.

In step 76 one or more color correction matrices may be selected to correct individual R, G, or B gains to achieve neutral balance of colors. Color balancing matrices may be based on the characteristics of different illuminant types. The color balancing matrices may also be based on the usage patterns of device 10. For example, the color balancing matrices may be optimized to balance colors in the lighting situations most used by the user or controlling system. One or more color correction matrices may be used to correct overall adjustment to the RGB signal gains for other image corrections, such as lightness balance.

In step 70, the method 101 may process the RGB-NIR image signal data input to the recovery unit 60. The recovery unit 60 may perform one or more NIR subtraction operations (step 78) on the input signal (RGB-NIR) using the one or more subtraction matrices selected in step 74. The resultant signal may be an RGB image signal (note the absence of the NIR component signal), with an attenuated influence of NIR band light on the signals from the color. In step 80, this resultant signal (R′G′B′) may be processed in by performing one or more appropriate color corrections, using the one or more color correction matrices selected in step 76. In step 82, the resultant signal may be a standard RGB signal (sRGB) that can be output to a standard RGB image signal processor or storage unit (sometimes referred to herein as RGB processor 62, FIG. 5).

The RGB processor 62 may correspond to current or previous generation RGB-based signal processing products. The RGB processor 62 may contain one or more integrated circuits (e.g., image processing circuits, microprocessors, field programmable gate arrays, storage devices such as random-access memory and non-volatile memory, etc.). The RGB processor 62 may share these components with the circuitry 18.

In step 78, the NIR subtraction operation may be based on a matrix multiplication. For example, one of the NIR subtraction operations applied to the RGB-NIR image signal in step 78 may be illustrated in the equation 1 below:

$$[ \begin{matrix}{R}^{′} \\ {G}^{′} \\ {B}^{′}\end{matrix} ] = {S}_{3 \times 4} [ \begin{matrix}Rin \\ Gin \\ Bin \\ NIRin\end{matrix} ] \qquad ( 1 )$$

The matrix S in equation 1 is a NIR subtraction matrix composed of three rows and four columns, which may be applied to the input vector received in step 70 of method 101. In the method 101, matrix S in equation 1 may be determined or selected according to the illuminant type found in step 72. The matrix S may also be decomposed into a plurality of matrices, if for example it is found to be computationally efficient to do so.

An example of the color correction operations applied in step 80 to the R′G′B′ image signal obtained in step 78 in method 101 may be illustrated in the equation 2 below:

$$[ \begin{matrix}sR \\ sG \\ sB\end{matrix} ] = C {1}_{3 \times 3} C {2}_{3 \times 3} … {CN}_{3 \times 3} [ \begin{matrix}{R}^{′} \\ {G}^{′} \\ {B}^{′}\end{matrix} ] \qquad ( 2 )$$

The matrices C1, C2 . . . CN are color correction matrices composed of three rows and three columns, which may be successively or individually applied to the input to step 80, the R′G′B′ image signal. In the method 101, matrices C1, C2 . . . CN may be determined or selected according to the illuminant type found in step 72. The matrices C1, C2 . . . CN may also be decomposed into a further plurality of matrices, if for example it is found computationally efficient to do so. The color correction operations may correspond to the signal processing operations applied to signal data from traditional image sensors, such as sensors using a traditional Bayer filter array above the array 26 of imaging pixels 24. The color correction operations may be optimized to produce an image representative of the colorimetry of the original scene objects under a standard illuminant, such as International Commission on Illumination (CIE, for its French name) Standard Illuminant D65, regardless of the actual scene light source.

Once the color balanced sRGB signal is obtained from a color correction operation on R′G′B′ in step 80, it may be output to an RGB image signal processor or storage (sometimes referred to herein as RGB processor 62, FIG. 5) in step 82 of method 101 (FIG. 6). RGB processor 62 may be a signal processing unit of framework that is compatible with RGB image signals obtained from traditional camera modules without NIR channels. The processing RGB processor 62 performs may include sharpening or gamma correction operations.

The method 102 described in FIG. 7 may be used to process RGB-NIR image signals from the camera module 12. To produce a color accurate RGB image signal, the data is first received by the recovery unit 60 (step 70, FIG. 7). In step 86 of method 102, a universal NIR subtraction operation may be performed with a universal NIR subtraction matrix, illustrated by equation 3 below:

$$[ \begin{matrix}{R}^{*} \\ {G}^{*} \\ {B}^{*}\end{matrix} ] = {U}_{3 \times 4} [ \begin{matrix}Rin \\ Gin \\ Bin \\ NIRin\end{matrix} ] \qquad ( 3 )$$

The matrix U in equation 3 is a universal NIR subtraction matrix composed of three rows and four columns, which may be applied to the input vector received in step 70 of method 102. In the method 102, matrix U is a matrix of values applicable to input image signals of a scene illuminated by any illuminant type.

Matrix U may be based or determined on the light source deemed most frequently to be encountered in product usage. Matrix U may also or alternatively be based on a light source whose NIR correction matrix provides somewhat more aggressive accounting for NIR effects to err on the side of over correction rather than risk occasional under correction with visible NIR effects. Matrix U may also or alternatively be based on the correction profile for a CIE standard illuminant. Matrix U may also or alternatively be based on an average of matrices computed over a range of typically encountered light sources. The matrix U may be determined by one of a plurality of optimization frameworks for a NIR subtraction matrix and a given or standard light source, such as a least-squares optimization, artificial neural networks, genetic algorithms, or any other optimization framework. The matrix U may be decomposed into a plurality of matrices, if for example it is found computationally efficient to do so.

An example of the color correction operations applied operations applied in step 88 to the R*G*B* image signal obtained in step 86 in method 102 may be illustrated in the equation 4 below:

$$[ \begin{matrix}sR \\ sG \\ sB\end{matrix} ] = D {1}_{3 \times 3} D {2}_{3 \times 3} … {DN}_{3 \times 3} [ \begin{matrix}{R}^{*} \\ {G}^{*} \\ {B}^{*}\end{matrix} ] \qquad ( 4 )$$

The matrices D1, D2 . . . DN are color correction matrices composed of three rows and three columns, which may be successively or individually applied to the input to step 88, the R*G*B* image signal. The matrices D1, D2 . . . DN may be decomposed into a further plurality of matrices, if for example it is found computationally efficient to do so. The color correction operations may correspond to the signal processing operations applied to signal data from traditional image sensors, such as sensors using a Bayer filter above the array 26 of imaging pixels 24. The color correction operations may be optimized to produce an image representative of the colorimetry of the original scene objects under a standard illuminant, such as CIE Standard Illuminant D65, regardless of the actual scene light source.

Once the color balanced sRGB signal is obtained from a color correction operation on R*G*B* in step 88, it may be output to an RGB processor 62, FIG. 5 in step 90 of method 102.

Methods 101 and 102 both may result in the production of a sRGB image that is color accurate. As they share an input step 70, the choice of which method to process the data by may be determined by the storage and processing circuitry 18. Because method 101 is more computationally expensive than method 102, this determination may be based on factors such as available power to the device 10, the capture rate of camera module 12, or an input from the user of device 10 that, for example, puts a constraint on the speed of image processing.

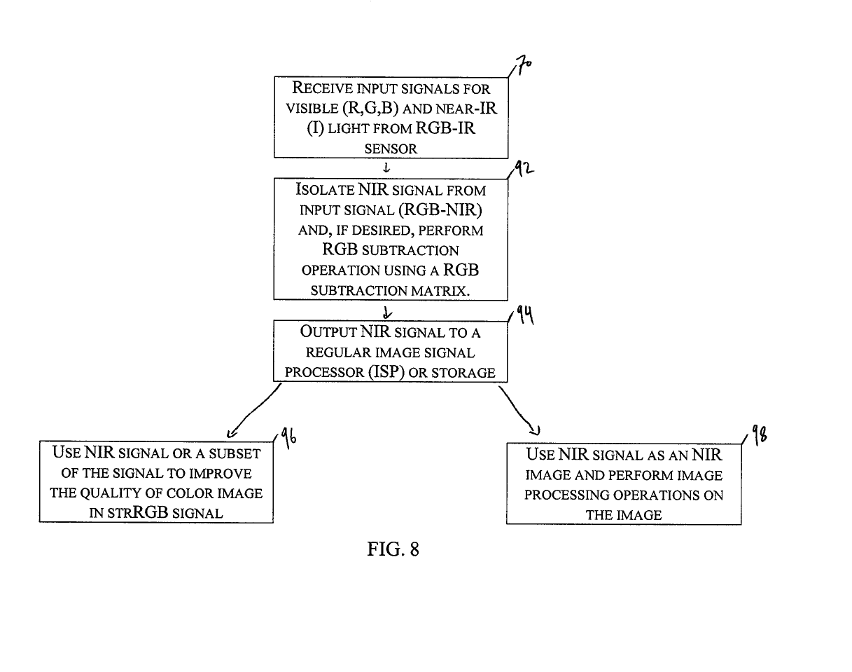

FIG. 8 shows illustrative steps that could be used to process the image signal data from the NIR channels. After the RGB-NIR image signal input is received by the recovery unit 60 in step 70, the NIR image signal may be isolated from the RGB image signal in step 92 (FIG. 8). The NIR image signal may be merely isolated, or if desired, isolated using a RGB subtraction operation. An example of mere isolation of the NIR image signal may be illustrated in the equation 5 below:

$$[ NIRin ] = [ \begin{matrix}0 & 0 & 0 & 1\end{matrix} ] [ \begin{matrix}Rin \\ Gin \\ Bin \\ NIRin\end{matrix} ] \qquad ( 5 )$$

In equation 5, illustrating mere isolation of the NIR image signal, the row vector multiplying the input vector from step 70 does not correct for any error in the NIR channel image signal due to unwanted sensitivity of the NIR channel signal 46 (FIG. 4) in the visible band of light (approximately 400-700 nm range). Because the unwanted sensitivity of the NIR channel image signal in the visible band is low, the result of mere isolation of the NIR image signal may be desired as such isolation is computationally simple. An example of the correction for unwanted sensitivity of the input NIR image signal in the visible band is illustrated in the equation 6 below:

$$[ NIR ] = {T}_{1 \times 4} [ \begin{matrix}Rin \\ Gin \\ Bin \\ NIRin\end{matrix} ] \qquad ( 6 )$$

The matrix T is a RGB subtraction matrix composed of one row and four columns. Matrix T may be based or determined on the light source deemed most frequently to be encountered in product usage. Matrix T may also or alternatively be based on a light source whose RGB correction matrix provides somewhat more aggressive accounting for RGB effects to err on the side of over correction rather than risk occasional under correction with RGB interference effects in the NIR image. Matrix T may also or alternatively be based on a CIE standard illuminant. Matrix T may also or alternatively be based on an average of matrices computed over a range of typically encountered light sources. The matrix T may be determined by one of a plurality of optimization frameworks for a NIR subtraction matrix and a given or standard light source, such as a least-squares optimization, artificial neural networks, genetic algorithms, or any other optimization framework.

Following step 92, the NIR image signal may be output to a regular image signal processor for NIR images 64 (sometimes referred to herein as NIR processor 64). NIR processor 64 may be a signal processing unit of framework that is compatible with greyscale signals obtained from traditional greyscale image sensors. The NIR processor 64 may utilize the NIR image signal or a subset of the NIR image signal to improve the quality of the sRGB color image produced by the recovery unit 60 (step 96). To accomplish this, it may send or receive data to the RGB processor RGB processor 62. The NIR processor 64 may improve the quality of the sRGB image by using the NIR image signal determining color correction matrices to be applied to the RGB image signal in RGB processor 62. The NIR processor 64 may improve the quality of the sRGB image by using the NIR signal or a subset of the NIR signal to determine the scene illuminant and thus determining or selecting appropriate image processing operations to be performed upon the RGB image.

The NIR processor 64 may treat the NIR image signal as an image and perform image processing operations on the NIR image. This image may be output to users by converting the signal values to a greyscale image so it is visible, or to computer systems which use NIR image signals in their computer vision algorithms. The NIR image may also be used in remote or autonomous navigation of vehicles. The NIR image may also be used in gaming platforms to track movement. The NIR image may also be used in military and law enforcement applications that require imaging capabilities in scenarios with low levels of visible light.

What is claimed is:

1. A method of transforming an input image to an output image, comprising:
receiving an input signal from an image sensor, wherein the input signal comprises a color input signal that is based on an amount of visible light detected by the image sensor and an infrared input signal that is based on an amount of infrared light detected by the image sensor;
determining a scene illuminant type; and
performing at least one infrared subtraction operation on the color input signal to obtain a color output signal, wherein the infrared subtraction operation is based on the determined scene illuminant type and the infrared input signal.

2. The method defined in claim 1 wherein determining the scene illuminant type comprises determining the scene illuminant type based on user input.

3. The method defined in claim 1 wherein determining the scene illuminant type comprises determining the scene illuminant type based on the color input signal.

4. The method defined in claim 1 wherein determining the scene illuminant type comprises determining the scene illuminant type based on both the color input signal and the infrared input signal.

5. The method defined in claim 1 wherein determining the scene illuminant type comprises determining the scene illuminant type based on a proximity of scene illuminant characteristics to those of a plurality of standard illuminants defined by the International Commission on Illumination (CIE).

6. The method defined in claim 1 wherein determining the scene illuminant type comprises determining the scene illuminant type based on a proximity of scene illuminant characteristics to those of a plurality of non-standard illuminants.

7. The method defined in claim 1 wherein performing the at least one infrared subtraction operation on the color input signal to obtain a color output signal comprises multiplying an input vector by a subtraction matrix, wherein the subtraction matrix is based on the determined illuminant type and wherein the input vector includes values from the color input signal and the infrared input signal.

8. The method defined in claim 1, further comprising:
multiplying the color output signal by a color correction matrix, wherein the color correction matrix is based on the determined illuminant type.

9. A method of transforming an input image to an output image, comprising:
receiving an input signal from an image sensor, wherein the input signal comprises a color input signal that is based on an amount of visible light detected by the image sensor and an infrared input signal that is based on an amount of infrared light detected by the image sensor; and
performing at least one infrared subtraction operation on the color input signal using an infrared subtraction matrix to obtain a color output signal with attenuated infrared light influence.

10. The method of claim 9 wherein performing the at least one infrared subtraction operation on the color input image signal using the infrared subtraction matrix comprises multiplying an input vector by the infrared subtraction matrix, wherein the input vector includes values from the color input signal and the infrared input signal.

11. The method of claim 10 wherein the infrared subtraction matrix is populated by values that are determined by an optimization framework, wherein the optimization frame work selects matrix values that minimize a difference between a result of preliminary infrared subtraction operation and target color data.

12. The method of claim 10 wherein the infrared subtraction matrix is populated by values that are based on a light source deemed most frequently to be encountered in device usage.

13. The method of claim 10 wherein the infrared subtraction matrix is optimized for an infrared-rich scene illuminant.

14. The method of claim 10 wherein the values that populate the universal infrared subtraction matrix are based or determined by the correction profile for a CIE standard illuminant.

15. The method of claim 10 wherein the infrared subtraction matrix is populated by values that are based on an average of infrared subtraction matrices that are optimized for a range of typically encountered light sources.

16. The method of claim 9 wherein the input image is based on image data gathered under a scene illuminant and wherein the infrared subtraction matrix is independent of the scene illuminant.

17. A method of transforming an input image to an output image, comprising:
receiving an input signal from an image sensor, wherein the input signal comprises a color input signal that is based on an amount of visible light detected by the image sensor and an infrared input signal that is based on an amount of infrared light detected by the image sensor; and
performing at least one color subtraction operation on the input infrared signal using a color subtraction matrix to obtain an infrared output signal with attenuated visible light influence.

18. The method of claim 17 wherein performing at least one color subtraction operation on the input infrared signal comprises multiplying an input vector by a subtraction matrix, wherein the input vector includes values from the color input signal and the infrared input signal.

19. The method of claim 18 wherein the color subtraction matrix is populated by values that are determined by an optimization framework, wherein the optimization framework selects matrix values that minimize a difference between a result of a preliminary color subtraction operation and target infrared data.

20. The method of claim 19 wherein the values that populate the color subtraction matrix are based on a correction profile associated with a standard illuminant defined by the International Commission on Illumination (CIE).
